(19) United States
(12) Patent Application Publication
(10) Pub. No.: US 2011/0013382 A1
(43) Pub. Date: Jan. 20, 2011

(54) AREA LIGHT SOURCE AND DISPLAY DEVICE INCLUDING THE AREA LIGHT SOURCE

(75) Inventor: Takaji Numao, Osaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/935,004

(22) PCT Filed: Nov. 4, 2008
(86) PCT No.: PCT/JP2008/070009

§ 371 Date: Sep. 28, 2010

(30) Foreign Application Priority Data
Apr. 2, 2008 (JP) 2008-095682

(51) Int. Cl. G02F 1/13357

(52) U.S. Cl. 362/97.1

(57) ABSTRACT

An area light source (5) comprises a plurality of point light sources (12) and a light guide plate (9) having a light emitting surface for emitting light from the point light sources (12) as an are light. The light guide plate (9) includes a plurality of first light guide bars (10) and a plurality of second light guide bars (11), the first light guide bars (10) and the second light guide bars (11) having a plurality of holes (13) provided at constant intervals. The light guide plate (9) is configured such that the first light guide bars (10) and the second light guide bars (11) are combined in a lattice shape and the holes (13) of the first light guide bars (10) and the holes (13) of the second light guide bars (11) are disposed alternately adjacent to each other. The point light sources (12) are disposed at the holes (13).

### TECHNICAL FIELD

The present invention relates to an area light source and a display device including the area light source.

### BACKGROUND ART

In recent years, an area light source of a type that diffuses light from a point light source such as an LED (Light Emitting Diode) and the like by means of a light guide plate and the like is employed in a backlight unit of a liquid crystal display device (display device). As documents that describe a display device which includes an area light source of this type, there are patent document 1 and patent document 2.

In the area light source (area light source device) described in the patent document 1, a plurality of area light source device units are disposed. In the area light source device unit, three kinds of LEDs, that is, a red-light emitting (R) LED, a green-light emitting (G) LED and a blue-light emitting (B) LED and a single-color light mixing member that mixes the light from these LEDs with each other are disposed. And, the single-color light mixing member color-mixes the light emitted from the LEDs to generate even area light.

Besides, in the area light source described in the patent document 2, a light guide plate incorporated includes: a first backlight; a first light guide portion that guides light from the first backlight; a second backlight; and a second light guide portion that guides light from the second backlight. And, in the first backlight, a plurality of red-light (R) emitting LEDs and cyan (C) emitting LEDs are disposed; in the second backlight, a plurality of blue-light (B) emitting LEDs and green-light (G) emitting LEDs are disposed.

Moreover, a first sub-light guide portion of the first light guide portion and a second sub-light guide portion of the second light guide portion repeat alternately approaching and leaving to intersect each other. As a result of this, in the area light source described in the patent document 2, the light from the first backlight enters the first light guide portion and is output from a bent portion of the first sub-light guide portion; the light from the second backlight enters the second light guide portion and is output from a bent portion of the second sub-light guide portion. And, area light is obtained from the light output from each bent portion.
Patent document 1: JP-A-2006-269364
Patent document 1: JP-A-2007-141597

### DISCLOSURE OF THE INVENTION

### Problems to be Solved by the Invention

However, like the patent document 1, in an area light source that includes a plurality of area light source device units, it is hard to unitarily form a complicated-shape area light source device unit. Accordingly, in such an area light source device, a process for combining the plurality of area light source units with each other becomes necessary. Accordingly, in the fabrication of the area light source device described in the patent document 1, the working processes increase and the fabrication processes become complicated.

On the other hand, in the area light source described in the patent document 2, because the first sub-light guide portion and the second sub-light guide portion only repeat approaching and leaving to intersect each other, the area light source is fabricated without undergoing complicated fabrication processes unlike the area light source device described in the patent document 1. However, in the area light source described in the patent document 2, it is impossible to adjust the amount of emitted light corresponding to every area of the light guide portion by means of the first backlight and the second backlight.

The present invention has been made to solve the above problems; and it is an object of the present invention to provide an area light source in which it is possible to adjust the amount of emitted light for every area and the fabrication processes are easy.

### Means for Solving the Problem

An area light source includes: a plurality of point light sources; and a light guide plate that has a light output surface that outputs light emitted from the plurality of point light sources as area light. In this area light source, the light guide plate includes a plurality of first light guide bars and a plurality of second light guide bars; and the first light guide bar and the second light guide bar are provided with a plurality of hole portions disposed at predetermined intervals. And, the light guide plate combines the first light guide bar and the second light guide bar into a checker shape; and neighbors alternately the hole portion of the first light guide bar and the hole portion of the second light guide bar to each other; and the point light source is disposed in the hole portion.

According to this, the hole portions that are disposed in the first light guide bar and the second light guide bar alternately neighbor to each other; and the first light guide bar and the second light guide bar combine with each other, so that the light guide plate is completed. Accordingly, the hole portions are disposed into a checker shape and also the point light sources disposed in the hole portions are disposed into a checker shape. As a result of this, the area light source includes the plurality of point light sources arranged at equal intervals and generates even area light.

Besides, each point light source is controlled, so that the amount of light of the area light source is accurately adjusted. Besides, because the light guide plate combines the first light guide bar and the second light guide bar with each other into the checker shape, for example, if the plurality of point light sources are disposed on a board in advance at positions corresponding to the positions of the hole portions, the plurality of point light sources and the light guide plate are combined with each other in one process. Accordingly, even the area light source that has a complicated mechanism is easily fabricated.

Besides, it is preferable that the first light guide bar and the second light guide bar have a wave shape; and the first light guide bar and the second light guide bar have a light output region that outputs the light emitted firm the point light source to outside and a brightening region where the hole portion is disposed.

According to this, when the light guide plate is seen from a cross section, for example, the light output region is disposed at a convex portion of the wave shape; and the hole portion is formed in a concave portion of the wave shape to dispose the brightening region. As a result of this, a region that extends from the brightening region to the light output region serves as a light mix region where light from the brightening region enters. Because of this, the light emitted from the point light source disposed in the hole portion is sufficiently mixed in the light mix region and output from the light output region. Accordingly, an area light source that curbs color unevenness and brightness unevenness is achieved.

Besides, it is preferable that the light output regions of the first light guide bar and the second light guide bar output the light emitted from a plurality of point light sources adjacent to the light output region.

According to this, for example, in the first light guide bar and the second light guide bar that have the wave shape, the light output region is disposed at the convex portion of the wave shape; and the brightening region is disposed at the concave portion of the wave shape, so that two brightening regions are disposed on both sides of the light output region. Because of this, the light output region outputs the light transmitted from the two brightening regions disposed on both sides of itself. Accordingly, the amount of light output from the light output region increases. Besides, even if one point light source becomes defective, the light output region is supplied with the light from the other point light source and becomes able to output the light. Because of this, the service life of the area light source extends.

Besides, it is preferable that the point light source keeps a light emitting direction of itself substantially parallel to a light output surface of the light guide plate.

According to this, the light that goes from the point light source to the light mix region increases and the light that is output from the light output region increases. Besides, the light from the point light source is prevented from leaking from the hole portion.

Besides, it is preferable that a surface on which the point light source is disposed includes a light reflection member.

According to this, the light guide plate combines the first light guide bar and the second light guide bar with each other into the checker shape; and at the position of the convex portion of the wave shape of one light guide bar, the concave portion of the wave shape of the other light guide bar is situated, so that the light, which goes in an upward direction from the brightening region disposed in the concave portion of the one light guide bar, reflects off the light reflection member disposed at the convex portion of the other light guide bar and goes to the light mix region. Accordingly, an area light source that improves the use efficiency of light is achieved.

Besides, it is preferable that a bonding material that has a refractive index equal to or larger than refractive indices of the first light guide bar and the second light guide bar is disposed in the hole portion; and the point light source is disposed in the hole portion via the bonding material.

According to this, if the point light source is sufficiently small compared with the hole portion, the point light source is covered by the bonding material disposed in the hole portion, so that reflection of the light emitted from the point light source, which occurs in a case where the light is output into the air, is curbed by the bonding material that has a refractive index equal to or larger than the refractive indices of the first light guide bar and the second light guide bar. As a result of this, the amount of light output from the light output region increases and the use efficiency of light by the area light source improves.

Here, it is possible to say that also a display device which includes the above area light source is the present invention.

### Advantages of the Invention

The light guide plate of the area light source includes the first light guide bar and the second light guide bar; the plurality of hole portions disposed in the first light guide bar at the predetermined intervals and the plurality of hole portions disposed in the second light guide bar at the predetermined intervals alternately neighbor to each other. And, the point
light source is disposed in the hole portion. As a result of this, the area light source includes the plurality of point light sources arranged at the equal intervals and generates even area light. Besides, because each point light source is controlled, the amount of light of the area light source is accurately adjusted.

Moreover, the light guide plate combines the first light guide bar and the second light guide bar with each other into the checker shape; and disposes the hole portion in a surface of the light guide plate. Because of this, the plurality of point light sources are disposed on a surface of a board corresponding to the positions of the hole portions. As a result of this, the board and the light guide plate join to each other, so that the plurality of point light sources and the light guide plate combine with each other in one process. Accordingly, even an area light source that has a complicated mechanism is easily fabricated.

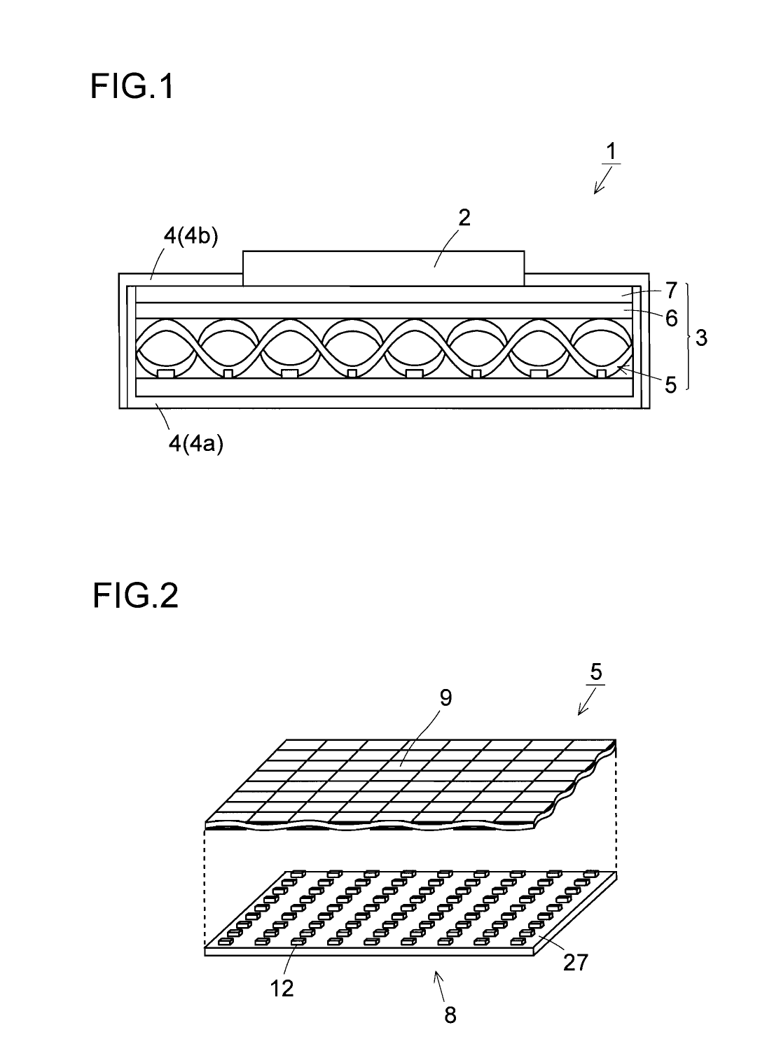

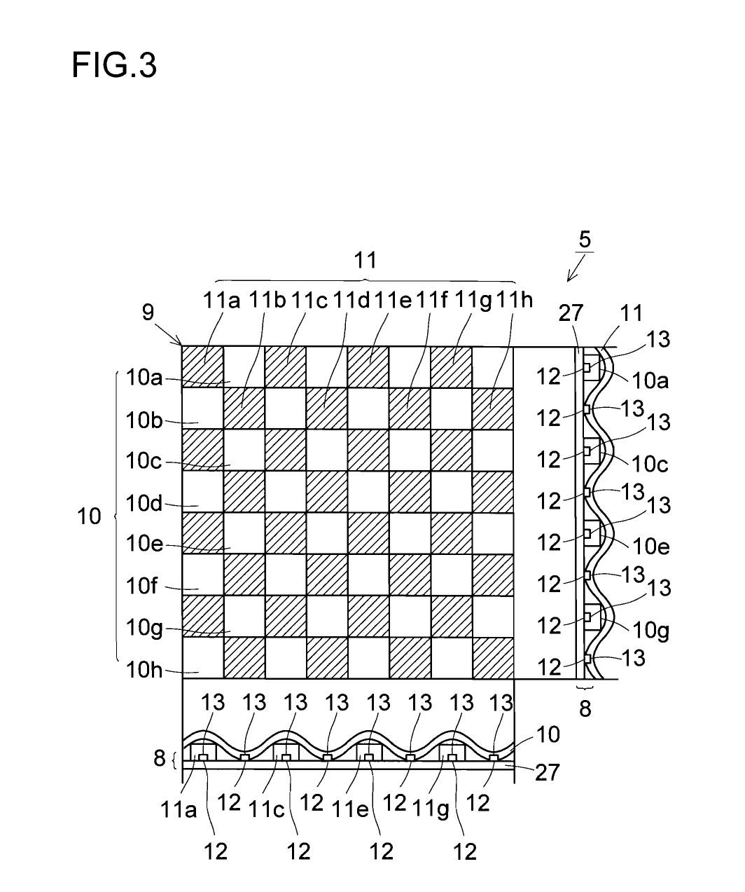

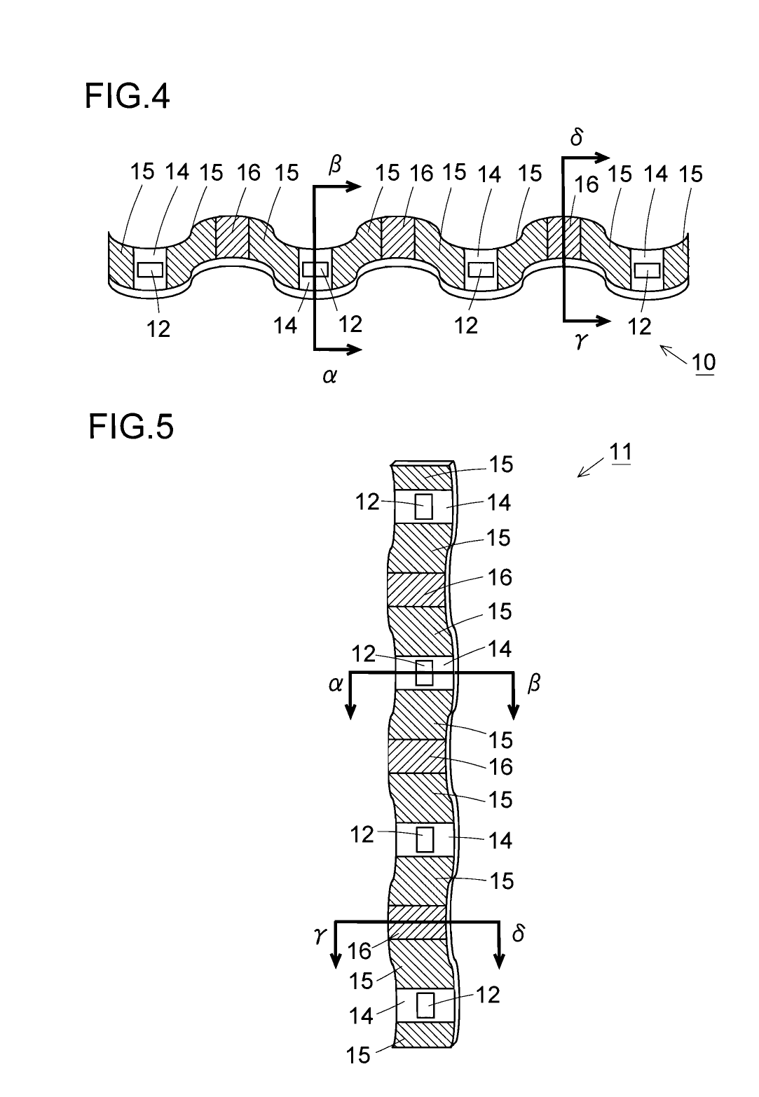

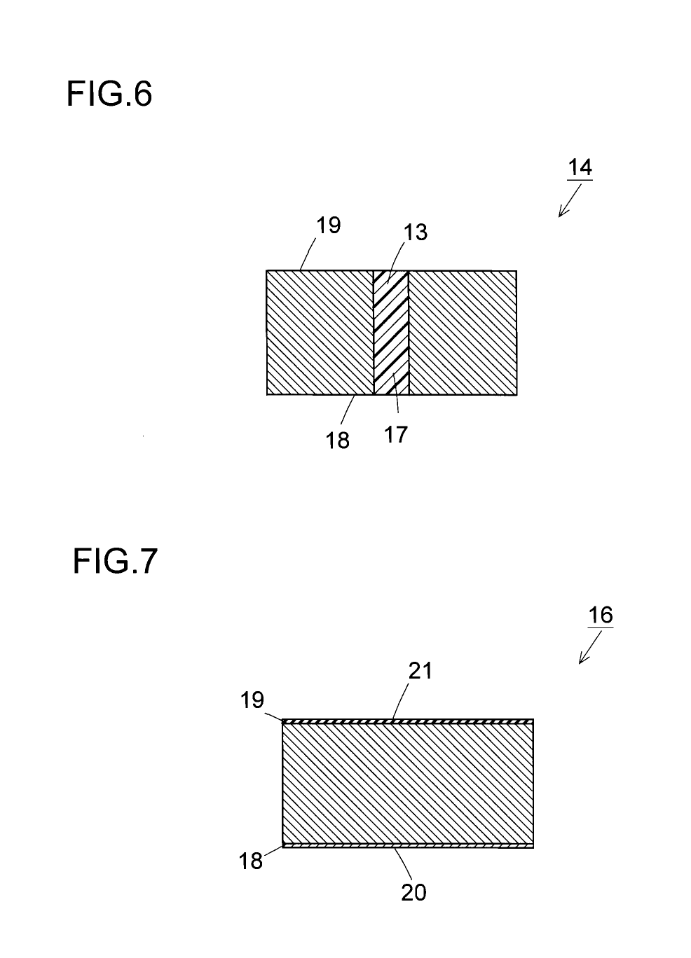

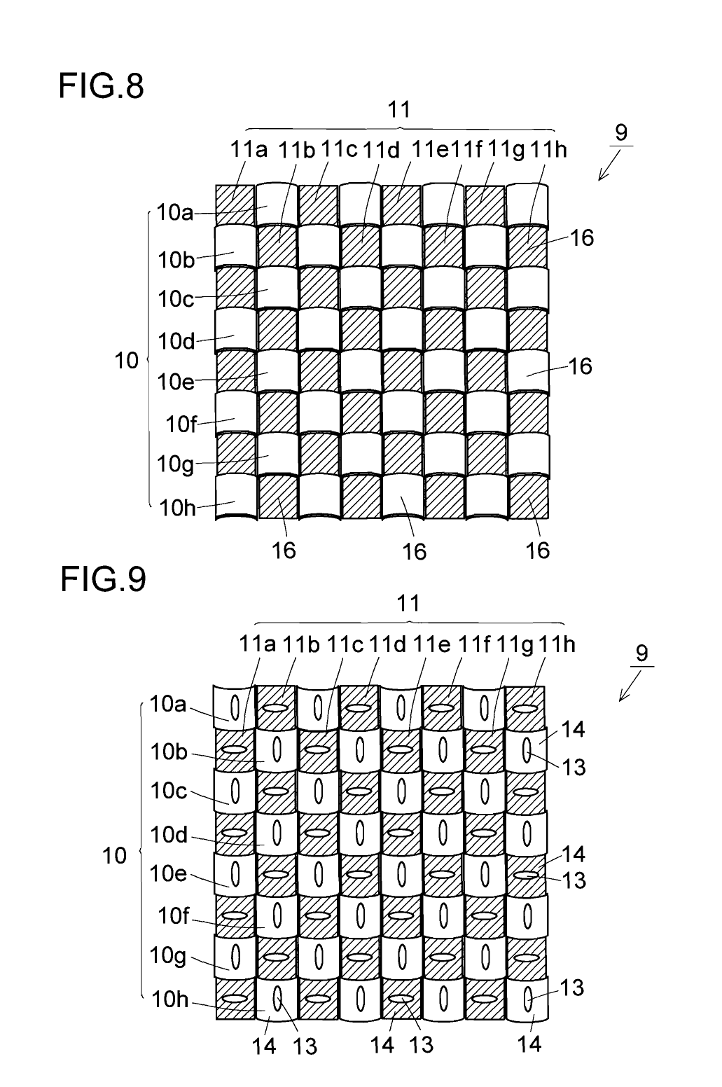

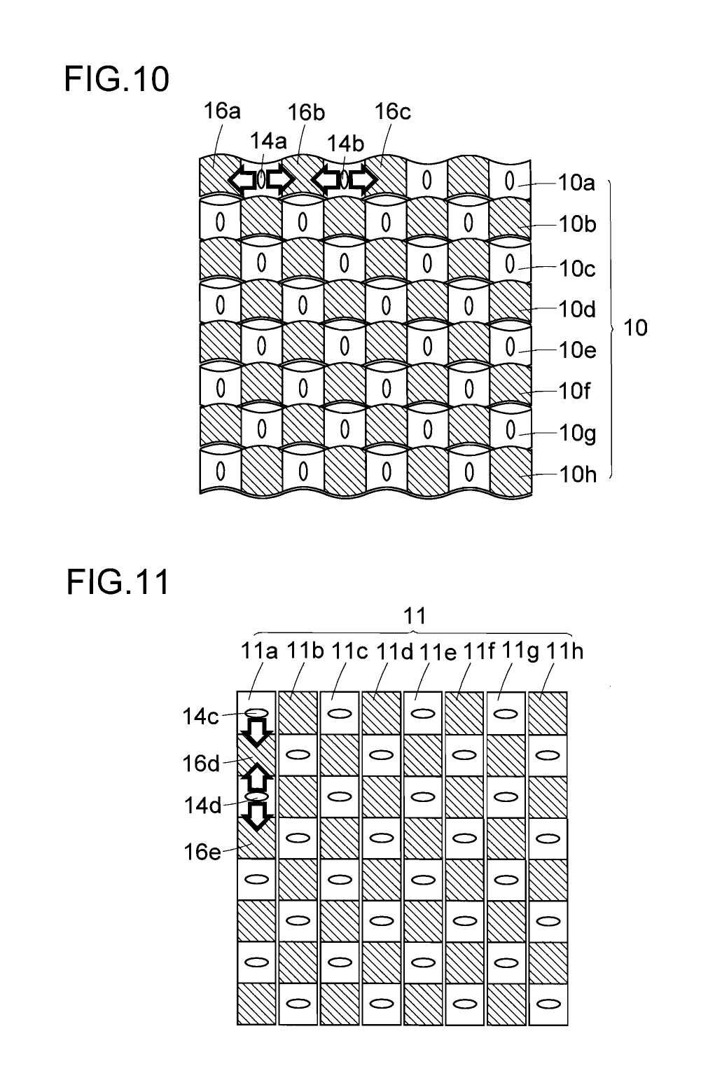

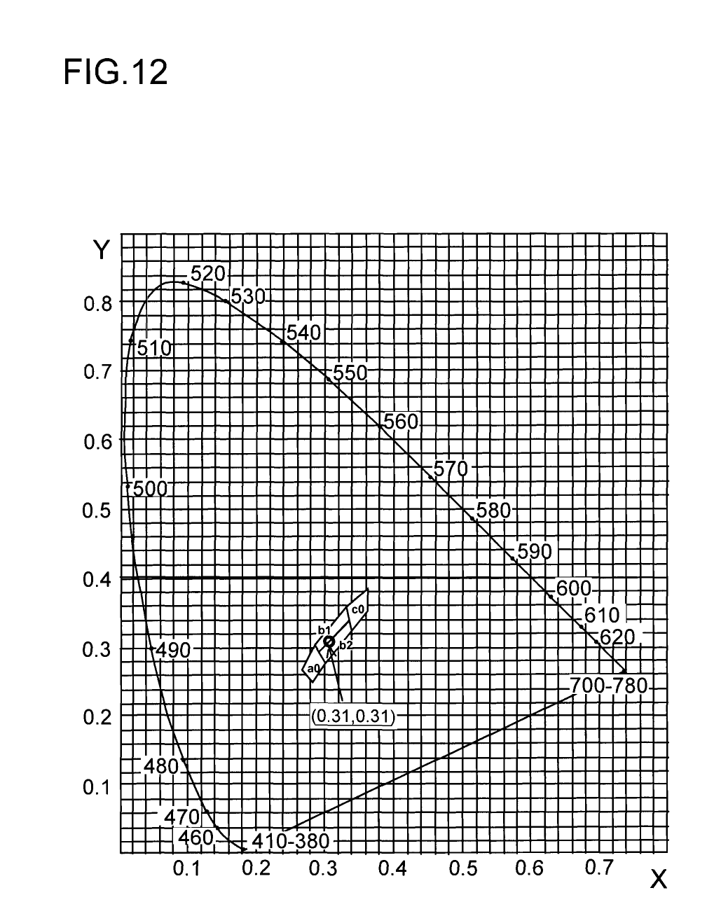

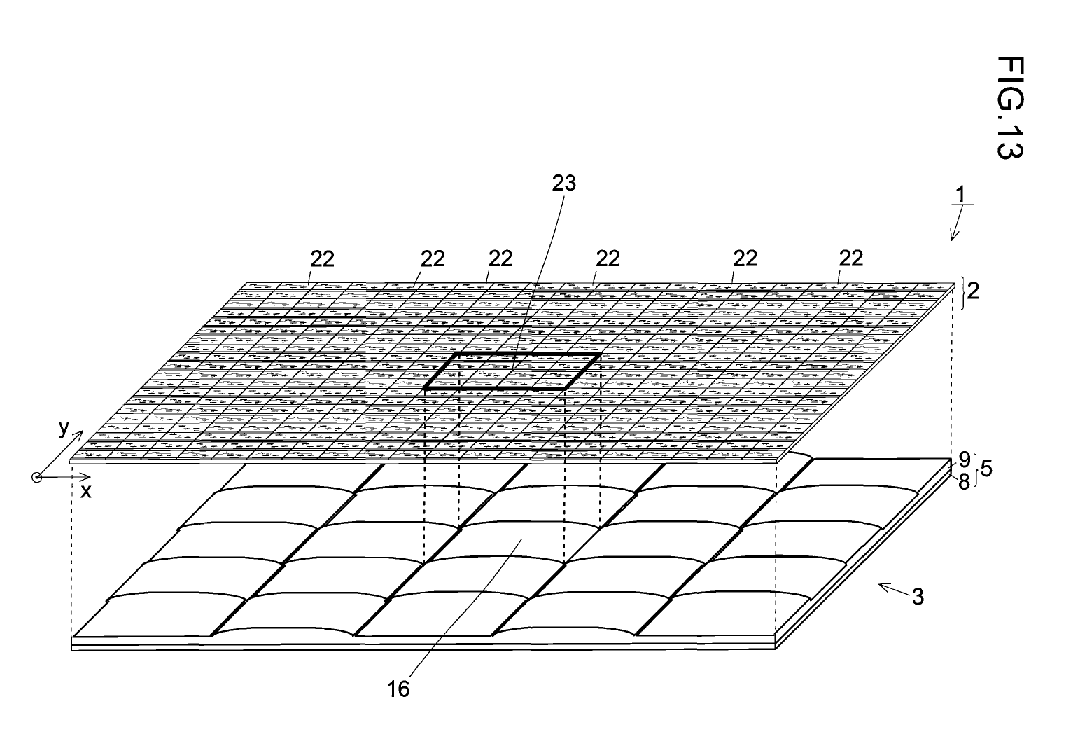

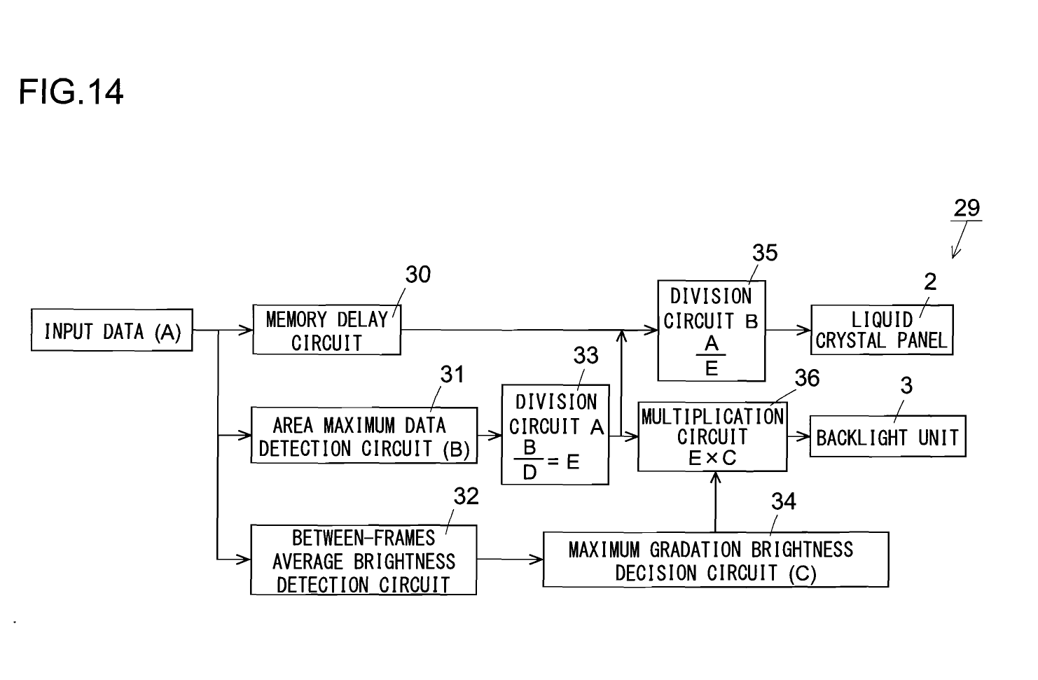

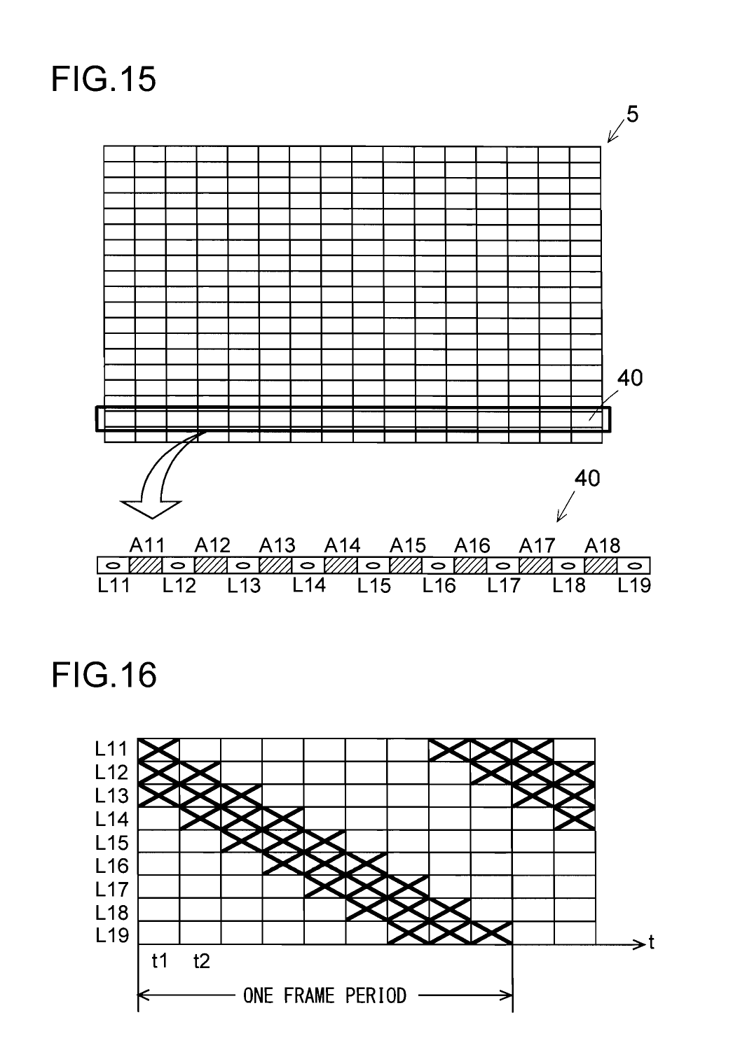

### BRIEF DESCRIPTION OF THE DRAWINGS

[FIG. 1] is a sectional view showing a display device.

[FIG. 2] is an exploded sectional perspective view showing an area light source.

[FIG. 3] is a developed view of an area light source seen from top.

[FIG. 4] is a plan view of a first light guide bar.

[FIG. 5] is a plan view of a second light guide bar.

[FIG. 6] is a sectional view of a brightening region cut along an α β line in FIG. 4 or FIG. 5.

[FIG. 7] is a sectional view of a light output region cut along a γ δ line in FIG. 4 or FIG. 5.

[FIG. 8] is a top view of a light guide plate.

[FIG. 9] is a bottom view of a light guide plate.

[FIG. 10] is a plan view showing a light output direction of a first light guide bar.

[FIG. 11] is a plan view showing a light output direction of a second light guide bar.

[FIG. 12] is a chromaticity graph of a surface mount type LED.

[FIG. 13] is an exploded perspective view of a display device.

[FIG. 14] is a flow chart showing an operation flow of a display means of a display device.

[FIG. 15] is an enlarged plan view of one taken from first light guide bars that constitute a light guide plate.

[FIG. 16] is a table showing an operation time of a point light source of the first light guide bar shown in FIG. 15 versus time.

### LIST OF REFERENCE SYMBOLS

1 display device

2 liquid crystal display panel

3 backlight unit

4 housing

5 area light source

6 diffusion plate

7 optical sheet

8 light source board

9 light guide plate

10(10a to 10h), 40 first light guide bars

11(11a to 11h) second light guide bar

12, L11 to L19 point light sources

13 hole portion

14 brightening region

16, A11 to A18 light output regions

18 lower surface

19 upper surface

20 light reflection member

21 light capture portion

29 display means

### BEST MODE FOR CARRYING OUT THE INVENTION

The embodiments of the present invention are described below with reference to the drawings.

[Display Device]

FIG. 1 is a sectional view showing a display device. A display device 1, as shown in FIG. 1, includes: a liquid crystal panel 2; a backlight unit 3; and a housing 4 (4a, 4b).

The backlight unit 3 includes: an area light source 5; a diffusion plate 6; and an optical sheet 7. The area light source 5 includes a light source board 8 and a light guide plate 9. Besides, the diffusion plate 6 is an acryl-relative resin in which particles having different refractive indices are mixed and is piled up (laminated) on the area light source 5. Besides, the optical sheet 7 is an acryl-relative resin that is piled up on the diffusion plate 6 and formed into a lens shape. And, the diffusion plate 6 and the optical sheet 7 scatter and diffuse area light from the area light source 5, thereby generating even light. Incidentally, details of the area light source 5 are described later.

The housing 4 (4a, 4b) is an accommodation body that is formed of a metal such as aluminum and the like. In detail, the housing 4 includes a groove portion for disposing the backlight unit 3 therein. On the other hand, the housing 4b is so disposed as to cover the housing 4a and is a lid to enclose the housing 4a. Because of this, the housing 4b includes a groove portion to dispose the housing 4a therein.

Besides, the housing 4b includes a through-hole at a position that faces the backlight unit 3 in the housing 4a. And, the liquid crystal panel 2 is disposed in the through-hole formed through the housing 4b. As a result of this, the liquid crystal panel 2 is piled up on the optical sheet 7 of the backlight unit 3 disposed in the housing 4a.

And, in the above display device 1, the area light emitted from the area light source 5 passes through the diffusion plate 6 and the optical sheet 7 to become even light. Moreover, the light enters the liquid crystal panel 2 piled up on the optical sheet 7 and the liquid crystal panel 2 uses the light to display an image.

[Area Light Source]

Here, the area light source 5 in the backlight unit 3 is described by using the following drawings. FIG. 2 is an exploded sectional perspective view showing the area light source 5. FIG. 3 is a developed view of the area light source 5 seen from an upper surface (incidentally, this upper surface is a surface of the area light source 5 that faces the diffusion plate 6).

As shown in FIG. 2, the area light source 5 includes the light source board 8 and the light guide plate 9. The light source board 8 includes: point light sources 12 like a plurality of LEDs (Light Emitting Diode); and a board 27 on which these point light sources 12 are disposed. On the other hand, the light guide plate 9 is a member that guides the light from the light source board 8 and converts the light into the area light.

In detail, as shown in FIG. 3, the light guide plate 9 includes: a plurality of first light guide bars 10 (10a to 10h); and a plurality of second light guide bars 11 (11a to 11h). And, the point light sources 12 of the light source board 8 are disposed in the hole portion 13 formed in the first light guide bar 10 and in the hole portion 13 formed in the second light guide bar 11, so that the light from the point light source 12 is converted into the area light (in short, the light guide plate 9 outputs area light). Here, hereinafter, the light guide plate 9 is described in detail.

FIG. 4 is a plan view of the first light guide bar 10; FIG. 5 is a plan view of the second light guide bar 11. FIG. 6 is a sectional view showing a brightening region 14 contained in the first light guide bar 10 and the second light guide bar 11; in detail, a sectional view of the brightening region 14 cut along an α β line in FIG. 4 or FIG. 5. FIG. 7 is a sectional view showing a light output region 16 contained in the first light guide bar 10 and the second light guide bar 11; in detail, a sectional view of the light output region 16 cut along a γ δ line in FIG. 4 or FIG. 5.

FIG. 8 is a top view of the light guide plate 9 that faces the diffusion plate 6; FIG. 9 is a bottom view of the light guide plate 9 that faces the light source board 8. FIG. 10 is a plan view showing a light output direction of the first light guide bar 10; FIG. 11 is a plan view showing a light output direction of the second light guide bar 11 (see a black arrow for the output direction).

As shown in FIG. 4 and FIG. 5, the first light guide bar 10 and the second light guide bar 11 are each a flat band-shape body that is formed of an acryl-relative resin. Besides, both light guide bars 10, 11 have a heaving shape (wave shape) along their own longitudinal directions (directions in which both light guide bars 10, 11 extend). And, when the first light guide bar 10 and the second light guide bar 11 are seen from a section, the brightening region 14 is disposed in a concave portion of the wave shape that is in contact with the light source board 8. On the other hand, the light output region 16 is disposed at a convex portion of the wave shape that is away from the light source board 8.

And, in the brightening region 14, the hole portion 13 is formed and the point light source 12 is disposed. Because of this, in the first light guide bar 10 and the second light guide bar 11, a plurality of hole portions 13 are situated at predetermined intervals.

Besides, the region that extends from the brightening region 14 to the light output region 16 serves as a light mix region 15 that mixes (color-mixes) the light from the point light source 12 disposed in the brightening region 14 to generate an even color. And, because the light mix region 15 is disposed, the light output from the brightening region 14 is sufficiently mixed, so that light output which curbs color unevenness and brightness unevenness is achieved.

Here, the first light guide bar 10 and the second light guide bar 11 are, as described above, a flat band-shape body. Because of this, as shown in FIG. 6 and FIG. 7, when the first light guide bar 10 and the second light guide bar 11 are observed from a cross section perpendicular to the longitudinal direction, the cross sections of the first light guide bar 10 and the second light guide bar 11 have substantially a rectangular shape. Because of this, hereinafter, in the first light guide bar 10 and the second light guide bar 11, a surface that comes into contact with the light source board 8 is defined as a lower surface 18 and a surface that is away from the light source board 8 is defined as an upper surface 19.

Here, the brightening region 14 disposed in the first light guide bar 10 and the second light guide bar 10 is described in detail.

The brightening region 14 is provided with the hole portion 13 to disposed the point light source 12 of the light source board 8; the hole portion 13 is, as shown in FIG. 6, a through-hole that extends from the lower surface 18 to the upper surface 19 of the first light guide bar 10 and the second light guide bar 11; in detail, a through-hole that penetrates in substantially a vertical direction from the lower surface 18 to the upper surface 19.

Besides, to join the point light source 12, a bonding material 17, which is a thermosetting resin such as a phenyl-relative silicone resin (e.g., KER-2667 from Shin-Etsu Chemical Co., Ltd.), an organic denatured silicone resin (e.g., SCR-1011 from Shin-Etsu Chemical Co., Ltd.) or the like, is injected into the hole portion 13. Here, the bonding material 17 has a refractive index equal to or larger than the refractive indices of the first light guide bar 10 and the second light guide bar 11.

Besides, as described above, the hole portion 13 is a through-hole; however, is not limited to this. For example, the hole portion 13 may be an opening portion (opening portion recessed only from the lower surface 18) that has a concave shape on the lower surface 18 side. Besides, it is sufficient if the shape of the hole portion 13 has an adequately large size compared with the size of the point light source 12; and the shape is suitably changed in accordance with the point light source 12.

Next, the light output region 16 disposed in the first light guide bar 10 and the second light guide bar 11 is described in detail.

The light output region 16, as shown in FIG. 7, includes a light reflection member 20 that is formed by vapor-depositing a metal such as aluminum or the like onto the lower surface 18; and a light capture portion 21 that is constructed by forming the upper surface 19 into a lens shape. And, the light is captured in substantially a vertical direction from the light capture portion 21 by the light output region 16.

In the light guide plate 19 that includes the first light guide bar 10 and the second light guide bar 11 which have the above brightening region 14 and the light output region 16 described above, as shown in FIG. 8, the plurality of first light guide bars 10 (10a to 10h) and the plurality of second light guide bars 11 (11a to 11h) are combined with each other in such a way that the longitudinal direction of the first light guide bar 10 and the longitudinal direction of the second light guide bar 11 become perpendicular to each other.

In detail, the light output region 16 of the first light guide bar 10 and the light output region 16 of the second light guide bar 11 are so disposed as to alternately neighbor to each other, so that the light output region 16 of the first light guide bar 10 and the light output region 16 of the second light guide bar 11 are disposed into a checker shape (in short, the plurality of first light guide bars 10 and the plurality of second light guide bars 11 form a checker-shape (reticulate-shape) net). Because of this, the light output from each light output region (each light output surface) 16 of the first light guide bar 10 and the light output from each light output region (each light output surface) 16 of the second light guide bar 11 collect into the area light, so that the light output surface of the light guide plate 9 is completed.

Besides, because the light output region 16 of the first light guide bar 10 and the light output region 16 of the second light guide bar 11 are disposed into the checker shape, as shown in FIG. 9, the brightening region 14 of the first light guide bar 10 and the brightening region 14 of the second light guide bar 11 are also disposed into a checker shape; moreover, the hole portion 13 of the first light guide bar 10 and the hole portion 13 of the second light guide bar 11 are also disposed into a checker shape.

As described above, in the light guide plate 9, the light emitted from the point light source 12 disposed in the hole portion 13 enters the brightening region 14 of the first light guide bar 10 and the second light guide bar 11 via the hole portion 13. And, the light that enters the brightening region 14 goes to the two adjacent light mix regions 15; and the light output region 16 outputs the light obtained via the two adjacent light mix regions 15.

For example, as shown in FIG. 10, in the fist light guide bar 10a, light that goes from a brightening region 14a enters an adjacent light output region 16a and an adjacent light output region 16b, while light that goes from a brightening region 14b enters an adjacent light output region 16b and an adjacent light output region 16c. Because of this, for example, the light output region 16b receives the light from the brightening region 14a and the light from the brightening region 14b and outputs both light upward by means of the light capture portion 21.

Besides, for example, as shown in FIG. 11, in the second light guide bar 11a, light that goes from a brightening region 14c enters an adjacent light output region 16d. And, light that goes from a brightening region 14d enters an adjacent light output region 16d and an adjacent light output region 16e. Because of this, for example, the light output region 16d receives the light from the brightening region 14c and the light from the brightening region 14d and outputs both light upward by means of the light capture portion 21.

As a result of this, the light guide plate 9 outputs the light of the point light sources 12 disposed in the two brightening regions 14 from one light output region 16. Because of this, the amount of light output from the light output region 16 increases. Besides, even if the point light source 12 disposed in one brightening region 14 becomes defective, the light guide plate 9 is supplied with the light from the other point light source 12, so that the service life of the area light source 5 extends.

Besides, the light guide plate 9 disposes the brightening region 14 of the other light guide bar under the light output region 16 of one light guide bar. For example, as shown in FIG. 10 and FIG. 11, the light output region 16a of the first light guide bar 10a is disposed over the brightening region 14c of the second light guide bar 11a. And, the light reflection member 20 is situated on the lower surface 18 of the light output region 16a. Because of this, light that leaks from the brightening region 14c via the hole portion 13 is reflected by the light reflection member 20 of the light output region 16a and goes to the light mix region 15. Because of this, light leakage is prevented and the area light source 5 that improves the use efficiency of light is achieved.

Besides, the light source board 8, as shown in FIG. 3, disposes the plurality of point light sources 12 on the board 27 corresponding to the hole portions 13 that are disposed in the checker shape in the first light guide bar 10 and the second light guide bar 11. Here, the board 27 may be formed by combining a plurality of placement pieces with each other. This is because according to this, the size of the light source board 8 easily changes in accordance with the size of the backlight unit 3.

Besides, it is preferable that the light emitting direction of the point light source 12 is parallel to the light output surface of the light guide plate 9 (the light emitting direction is called a lateral direction). This is because according to this, the amount of light that goes from the point light source 12 to the light mix region 15 increases; and the amount of light output from the light output region 16 also increases.

However, as an example, there is the point light source 12 that emits light in the lateral direction; however, this is not limiting. For example, the point light source 12 that emits light in an upward direction which intersects the lateral direction may be disposed in the hole portion 13. In this case, two point light sources 12 are built into the hole portion 13 and disposed on the board 27 in such a way that the light emitting directions of these point light sources 12 become parallel to the board 27 and the light emitting directions of the two point light sources 12 go in directions opposite to each other.

[Color Rendering of Light from Area Light Source]

Here, it is described that color rendering of the light from the area light source 5, in detail, the light from the light guide plate 9 is excellent in the color rendering. In the light guide plate 9, one light output region 16 outputs the light from the two brightening regions 14. Because of this, by suitably changing white brightness of the point light source 12 in each brightening region 14, it is possible to obtain the light that is more excellent in the color rendering. Because of this, one example of this is described in detail.

FIG. 12 is a chromaticity graph of light emitted from a surface mount type LED.

The LED (e.g., from Nichia Corporation) as the point light source 12 is different in the white brightness from product to product. Because of this, even in the same product, as shown in FIG. 12, there various kinds of white chromaticity distributions of a0 to c0.

Here, for example, it is supposed that a white chromaticity to be obtained (x, y)=(0.31, 0.31). In this case, because there are only a few LEDs of such a product rank, in the conventional area light source, it is hard to obtain the light that has the desired white chromaticity.

However, in the area light source 5, the light output from the light output region 16 is generated from the light from the two point light sources 12. Because of this, for example, in the two LEDs, if one is an LED of the a0 rank and the other is an LED of the c0 rank; or if one is an LED of the b1 rank and the other is an LED of the b2 rank, both light mix with each other and the light output from the light output region 16 has a chromaticity approximate to the desired white chromaticity.

Because of this, in the area light source 5, it is possible not only to obtain the light that is excellent in the color rendering but also to dispose LEDs of various ranks as the point light sources 12 to be used. Accordingly, the cost of the area light source 5 decreases.

Incidentally, besides the white chromaticity, it is possible to conceive that it is true of LEDs which emit single-color light like red, green, blue or other single colors. Besides, in the two point light sources 12 that serve as the supply sources of the light which is output from one light output region 16, the white color may be generated from the color mixing of the emitted-light color from one point light source 12 and the emitted-light color from the other point light source 12.

[Other Items about Area Light Source]

The area light source 5 combines the following light source board 8 and light guide plate 9 with each other. And, the process for combining the light source board 8 and the light guide plate 9 is a process included in the process for fabricating the display device 1. In detail, in the process for fabricating the display device 1, in a case where the housing 4a is fitted into the housing 4b, the light guide plate 9 is pushed against the light source board 8, so that the point light source 12 is fitted into the hole portion 13.

Here, the bonding material 17 is disposed in the hole portion 13, and the size of the hole portion 13 is sufficiently large compared with the size f the point light source 12. Because of this, when the point light source 12 is fitted into the hole portion 13, the point light source 12 is buried into the bonding material 17. Here, the point light source 12 buried in the bonding material 17 is sintered for 1 to 5 hours under an environment of 120° C. to 150° C. in the process for fabricating the display device 1, so that the point light source 12 is encapsulated in the setting bonding material 17.

Here, the bonding material 17 has a refractive index equal to or larger than the refractive indices of the first light guide bar 10 and the second light guide bar 11. As a result of this, in comparison with a case where the point light source 12 is disposed in the air, the reflection of the light from the point light source 12 is curbed. Because of this, the amount of light output from the light output region 16 increases and the use efficiency of light by the area light source 5 improves.

Besides, the area light source 5 disposes the point light source 12 in each of the plurality of hole portions 13 formed in the first light guide bar 10 and the second light guide bar 11. Because of this, the amount of light and emitted-light color and the like from each point light source 12 are controlled, so that the amount of area light and emitted-light color from the area light source 5 are accurately adjusted.

In addition, the point light source 12 is disposed on the board 27 in advance corresponding to the position of the hole portion 13, so that the light source board 8 and the light guide plate 9 are joined to each other in one process. Because of this, even the area light source 5 that has the complicated mechanism described above is fabricated by means of the simple fabrication process.

Here, the light guide plate 9 included in the area light source 5 includes the first light guide bar 10 and the second light guide bar 11 that has the flat band-shape body. However, this is not limiting. For example, instead of the first light guide bar 10 and the second light guide bar 11, for example, even if an optical fiber that has a flat band-shape body is used, the area light source 5 is completed.

[Display Means Included in Display Device]

Here, a display means 29 of the display device 1 is described. FIG. 13 is an exploded perspective view of the display device 1(here, in FIG. 13, the diffusion plate 6, the optical sheet 7 and the housing 4 are omitted for convenience). FIG. 14 is a flow chart showing operation steps by the display means 29 of the display device 1.

As shown in FIG. 13, the liquid crystal panel 2 is a dot-matrix type liquid crystal panel in which pixels 22 are equally arranged into a checker shape. Moreover, the liquid crystal panel 2 employs an active-matrix system in which an active element such as a TFT (thin film transistor) or the like is disposed at each pixel 22; and the liquid crystal panel 2 is controlled in accordance with operation of the active element.

The active-matrix system is a system in which an electric voltage is applied to a conductor line that is disposed in an X-axis direction (direction parallel to this paper surface) shown in FIG. 13, so that ON/OFF states of the active element at each pixel 22 are changed; and, an electric voltage is applied to a conductor line that is disposed in a Y-axis direction (direction perpendicular to the X-axis direction), so that the light-transmission state of the pixel 22 at an active element in the ON state is controlled.

Besides, the display device 1 is designed in such a way that the number of pixels of the liquid crystal panel 2 becomes larger than the number of light output regions 16 that serve as the light output surfaces of the light guide plate 9. Because of this, for example, as illustrated in a region enclosed by a square in FIG. 13, 16 pixels of the liquid crystal panel 2 correspond to one light output region 16 in the backlight unit 3. For this reason, the combination of one light output region 16 and 16 pixels of the liquid crystal panel is defined as a one area 23.

The display means 29 of the display device 1 includes: a between-frames average brightness detection circuit 32; a maximum gradation brightness decision circuit 34; an area maximum data detection circuit 31; a division circuit A 33; a multiplication circuit 36; a memory delay circuit 30; and a division circuit B 35.

And, in the display means 29 of the display device 1, as shown in FIG. 14, first, the between-frames average brightness detection circuit 32 detects an average brightness of input data over a plurality of frame periods. Here, one frame period is data of one image displayed on the liquid crystal panel 2.

And, based on the detection result, the maximum gradation brightness decision circuit 34 converts the input data into a maximum gradation brightness C that corresponds to 256 gradations (8 bits).

On the other hand, the area maximum data detection circuit 31 detects image data B that is maximum of the 16-pixel data of the liquid crystal panel 2 which corresponds to the one area 23. The image data B is decided for every color of red (R), green (G) and blue (B). Here, the maximum brightness value, which is decided by a combination of the maximum transmission factor of the liquid crystal panel 2 and the amount of light output from the light output region 16 in the one area 23, is defined as D.

The division circuit A 33 divides the image data B by the maximum value D to calculate an increment value E. The increment value E has a value of 0 to 1.

The multiplication circuit 36 performs a process of E×C by using the increment value E obtained by the division circuit A 33, thereby converting each color into a brightness for every area 23 and outputting the brightness to the backlight unit 3.

On the other hand, the memory delay circuit 30 delays the input data A.

And, the division circuit B 35 performs a process (amplification process) of A/E by using the delayed input data A and the increment value E obtained via the division circuit A33 and outputs the amplified processed data to the liquid crystal panel 2. Here, the data output to the liquid crystal panel 2 is input into a source driver circuit of the liquid crystal panel 2, description of which is skipped.

As described above, the brightness of the entire display device 1 becomes A×C. Because of this, the brightness as a whole does not become low; the amount of light of the light output region 16 is adjusted for every area 23; and the amount of light of the backlight unit 3 becomes low. Because of this, low power consumption of the display device 1 is achieved.

Here, in the above display device 1, as ways of dropping the amount of light of the backlight unit 3, there is a way of changing an electric current flowing into the point light source 12 by fixing the light emitting period of the point light source 12; and a way of changing the light emitting period of the point light source 12 by fixing the electric current flowing into the point light source 12. The display means 29 is able to achieve the low power consumption of the display device 1 whichever way is used.

Besides, the data-rewriting timing in the display device 1 and the light-emitting timing of the point light source 12 are as follows. FIG. 15 is an enlarged plan view of one taken from the first light guide bars 10 that are included in the light guide plate 9. FIG. 16 is a table showing an operation time of the point light source 12 of the first light guide bar shown in FIG. 15 versus time.

The light output surface of the light guide plate 9 includes the light output regions 16 of the plurality of first light guide bars 10 and the light output regions 16 of the plurality of second light guide bars 11. Besides, the first light guide bar 10 and the second light guide bars 11 each separately include a plurality of light output regions 16; and each light output region 16 serves as a one area 23 of the display device 1.

Because of this, for description, for example, as shown in FIG. 15, rewriting of the image data for every area 23 in a first light guide bar 40 enclosed by a square is described. Here, the contents described hereinafter are also true of the second light guide bar 11.

The first light guide bar 40, as shown in FIG. 15, includes: a plurality of light output regions A11 to A18 that correspond to the respective one areas 23; and a plurality of point light sources L11 to L19 that emit light to the respective light output regions A11 to A18.

As a result of this, as described above, the light output regions A11 to A18 output the light emitted from the point light sources L11 to L19, which are disposed respectively on both sides, to the respective areas 23, so that each area 23 performs displaying. Here, to turn off the one area 23 to rewrite the data, it is required to turn off at least two of the point light sources L11 to L19 that are disposed on both sides of each of the light output regions A11 to A18. Because of this, the display device 1, as shown in FIG. 16, turns off three point light sources L11, L12, and L13 in a time frame t1.

As a result of this, the light output region A11 that outputs the light of the point light sources L11 and L12 and the light output region A12 that outputs the light of the light sources L12 and L13 are tuned off. And, the image data in the light output region A11 is rewritten into new image data that reflects the above result from the display means 29, while the image data in the light output region A12 is analyzed by the display means 29.

Next, the display device 1 turns off the point light sources L12, L13 and L14 in a time frame t2. And, the light output region A12 that outputs the light of the point light sources L12 and L13 and the light output region A13 that outputs the light of the point light sources L13 and L14 are tuned off. As a result of this, the image data in the light output region A12 is rewritten into new image data that reflects the result from the display means 29 that is analyzed in the time frame t1, while the image data in the light output region A13 is analyzed by the display means 29.

As described above, of the point light sources 12 disposed in each light guide bar, three point light sources 12 disposed in portions corresponding to three adjacent areas are turned off, so that the central one of the three areas is completely turned off. And, as the predetermined time t1 passes, the distance corresponding to a one area is shifted. And, the time from a turning-off to the next turning-off of the same area is set at 60 Hz or more at which a human does not feel a flicker. As a result of this, in the display device 1, even if a one area is turned off, the image quality and the like are not influenced.

Lastly, the present invention is not limited to the above embodiments: the light guide plate 5, which is composed by combining the plurality of first light guide bars and the plurality of second light guide bars into a checker shape, is suitably practicable.

1. An area light source including: a plurality of point light sources; and a light guide plate that has a light output surface that outputs light emitted from the plurality of point light sources as area light;
wherein the light guide plate includes a plurality of first light guide bars and a plurality of second light guide bas; and the first light guide bar and the second light guide bar are provided with a plurality of hole portions disposed at predetermined intervals;
the light guide plate combines the first light guide bar and the second light guide bar into a checker shape; and neighbors alternately the hole portion of the first light guide bar and the hole portion of the second light guide bar to each other; and
the point light source is disposed in the hole portion.

2. The area light source according to claim 1, wherein
the first light guide bar and the second light guide bar have a wave shape; and
the first light guide bar and the second light guide bar have: a light output region that outputs the light emitted from the point light source to outside; and a brightening region where the hole portion is disposed.

3. The area light source according to claim 2, wherein
the light output regions of the first light guide bar and the second light guide bar output the light emitted from a plurality of point light sources adjacent to the light output region.

4. The area light source according to claim 1, wherein
the point light source keeps a light emitting direction of itself substantially parallel to a light output surface of the light guide plate.

5. The area light source according to claim 1, wherein
a surface in which the point light source is disposed in the first light guide bar and in the second light guide bar includes a light reflection member.

6. The area light source according to claim 1, wherein
a bonding material that has a refractive index equal to or larger than refractive indices of the first light guide bar and the second light guide bar is disposed in the hole portion; and
the point light source is disposed in the hole portion via the bonding material.

7. A display device including the area light source according to claim 1.

8. A display device including the area light source according to claim 2.

9. A display device including the area light source according to claim 3.

10. A display device including the area light source according to claim 4.

11. A display device including the area light source according to claim 5.

12. A display device including the area light source according to claim 6.
